(19) United States
(12) Patent Application Publication
(10) Pub. No.: US 2015/0054789 A1
(43) Pub. Date: Feb. 26, 2015

(54) FILTER STRUCTURE OF INFRARED TOUCH MODULE

(71) Applicant: Asia Vital Components Co., Ltd., New Taipei City (TW)

(72) Inventor: Chih-Wei Chang, New Taipei City (TW)

(73) Assignee: ASIA VITAL COMPONENTS CO., LTD., New Taipei City (TW)

(21) Appl. No.: 13/974,008

(22) Filed: Aug. 22, 2013

(51) Int. Cl. G06F 3/042

(52) U.S. Cl. CPC G06F 3/0421
USPC 345/175

(57) ABSTRACT

A filter structure of infrared touch module includes a main body having an upper protrusion section and an extension section. The upper protrusion section and the extension section respectively extend from an upper end and a lower end of the main body in reverse directions. The upper protrusion section extends to upper sides of multiple infrared transmitters and multiple infrared receivers. The main body is positioned in front of the transmission faces of the infrared transmitters and the receiving faces of the infrared receivers to shield the transmission faces and the receiving faces. The extension section extends to a position between a transparent panel and a second circuit board.

### BACKGROUND OF THE INVENTION

1. Field of the Invention

The present invention relates generally to an infrared filter structure, and more particularly to a filter structure applied to infrared touch module.

2. Description of the Related Art

Infrared touch technique has the advantages of high transparency, sensitivity to the touch of any material and applicability to large-size display. Therefore, infrared touch technique is widely applied to various displays. An infrared touch display screen has infrared transmitters and infrared receivers correspondingly arranged on opposite sides of the surface of the display screen. The infrared transmitters and infrared receivers form an infrared network densely distributed over the surface of the display screen. In touch, the article (such as a finger) will partially interrupt the infrared network to calculate the touch position.

The infrared touch display screen necessitates an infrared transparent frame to ensure that the infrared receiver units receive the infrared rays without interference of the environmental light. Currently, the infrared transparent frame is generally arranged in two manners. According to the first manner, the side frame of the infrared touch display screen is made of an optical material, which is infrared transparent, while visible light nontransparent. According to the second manner, the side frame is made of a nontransparent material and an infrared filter is packaged on the side frame of the infrared touch display screen. In order to lower cost, currently the second manner is most often adopted. The infrared filter is made of a plastic material to which a dye is added. The infrared filters are generally classified into two types. The first type is high-pass filter, which is transparent to the light with a wavelength larger than 850 nm or 940 nm. The second type is low-pass filter, which is transparent to the light with a wavelength within a range from 925 nm to 955 nm.

FIGS. 1A and 1B show the second type of infrared filter. The display screen has a frame body 10. A display section 11 is defined in the frame body 10 corresponding to a display module 12. A transparent panel 13 is overlaid on the display module 12. Two sets of corresponding LED transmitters 14 and LED receivers 15 are arranged on the opposite sides of the frame body 10. The LED transmitters 14 and LED receivers 15 are disposed on a first circuit board 16 and exposed to upper surface of the transparent panel 13. The first circuit board 16 is electrically connected with a second circuit board 17. The first circuit board 16 is an LED circuit board, while the second circuit board 17 is a motherboard. A filter 18 is packaged on the frame body 10. The filter 18 has an upper protrusion section 181 and an extension section 182. The extension section 182 downward extends from a rear end of the upper protrusion section 181 and has a free end 1821. The upper protrusion section 181 extends into the frame body 10 and is positioned on upper side of the LED transmitters 14 and LED receivers 15. The extension section 182 shields the transmission faces of the LED transmitters 14 and the receiving faces of the LED receivers 15 from the affection of the environmental light.

The free end 1821 of the extension section 182 is fixedly adhered to the upper surface of the transparent panel 13 via a first adhesive bar 191. The lower surface of the transparent panel 13 is affixed to the second circuit board 17 via a second adhesive bar 192.

The above arrangement has some shortcomings. For example, the second circuit 17 is affixed to the transparent panel 13 by means of adhesion. In the case that it is necessary to detach the frame body 10 for replacing some components of the infrared touch display screen or repairing the infrared touch display screen, the second circuit board 17 must be separated from the transparent panel 13. Under such circumstance, the circuit or electronic components of the second circuit board 17 may be damaged. In this case, it will be impossible to reuse the second circuit board 17.

### SUMMARY OF THE INVENTION

It is therefore a primary object of the present invention to provide a filter structure of infrared touch module. The filter structure has an extension section adhered to the transparent panel, whereby the filter structure is more securely attached to the transparent panel and prevented from displacing or detaching from the transparent panel.

It is a further object of the present invention to provide the above filter structure. The main body of the filter structure is positioned above and in front of the infrared transmitters and the infrared receivers to shield the same. In addition, the extension section of the filter structure extends to a position between the transparent panel and a circuit board. In this case, the circuit board is not directly adhered to the transparent panel. Accordingly, when separating the circuit board from the transparent panel, the circuit board is prevented from being damaged.

It is still a further object of the present invention to provide the above filter structure, in which the extension section has an upper surface adhered to the transparent panel and a lower surface adhered to the circuit board.

It is still a further object of the present invention to provide the above filter structure, which is applied to an infrared touch module. When separating the circuit board from the transparent panel, the circuit board is prevented from being damaged. Therefore, the infrared touch module is reworkable.

To achieve the above and other objects, the filter structure of infrared touch module of the present invention is applied to a side frame of the infrared touch module. The side frame has multiple infrared transmitters and multiple infrared receivers. The infrared transmitters and infrared receivers are disposed on a first circuit board. Each infrared transmitter has a transmission face. Each infrared receiver has a receiving face. The first circuit board is connected with a second circuit board. The side frame defines a window therein. A transparent panel is positioned under the side frame in alignment with the window. The transparent panel has a transparent section exposed to the window, a concealed section around the transparent section corresponding to the second circuit board and an outer periphery. The filter structure includes a main body having an upper protrusion section and an extension section. The upper protrusion section and the extension section respectively angularly extend from an upper end and a lower end of the main body in reverse directions. The upper protrusion section extends to upper sides of the infrared transmitters and infrared receivers. The extension section extends to a position between the transparent panel and the second circuit board.

In the above filter structure of the infrared touch module, the extension section has an upper surface corresponding to the concealed section of the transparent panel and a lower surface corresponding to the second circuit board. A first adhesive layer is disposed between the upper surface of the extension section and the concealed section of the transparent panel. A second adhesive layer is disposed between the lower surface of the extension section and the second circuit board.

In the above filter structure of the infrared touch module, the upper protrusion section has a protrusion end and the extension section has an extension end. The upper protrusion section and the extension section are positioned on different levels.

In the above filter structure of the infrared touch module, a gap is defined between the outer periphery of the transparent panel and the main body of the filter structure.

In the above filter structure of the infrared touch module, the main body of the filter structure is formed with a recess on upper side of the extension section. The outer periphery of the transparent panel is received in the recess.

According to the above arrangement, the circuit board is not directly adhered to the transparent panel. Therefore, when separating the circuit board from the transparent panel, the circuit board is prevented from being damaged. Moreover, the filter structure is more securely attached to the transparent panel and prevented from displacing or detaching from the transparent panel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a top view of a conventional infrared touch module;

FIG. 1B is a sectional view of a part of the conventional infrared touch module of FIG. 1;

FIG. 2 is a top view of the infrared touch module of the present invention;

FIG. 3A is a sectional view of a first embodiment of the filter structure of the present invention;

FIG. 3B is a sectional view showing that the first embodiment of the filter structure of the present invention is applied to an infrared touch module;

FIG. 3C is a sectional view showing a first manner in which the first embodiment of the present invention is detached;

FIGS. 4A and 4B are sectional views showing a second manner in which the first embodiment of the present invention is detached;

FIG. 5A is a sectional view of a second embodiment of the filter structure of the present invention; and

FIG. 5B is a sectional view showing that the second embodiment of the filter structure of the present invention is applied to an infrared touch module.

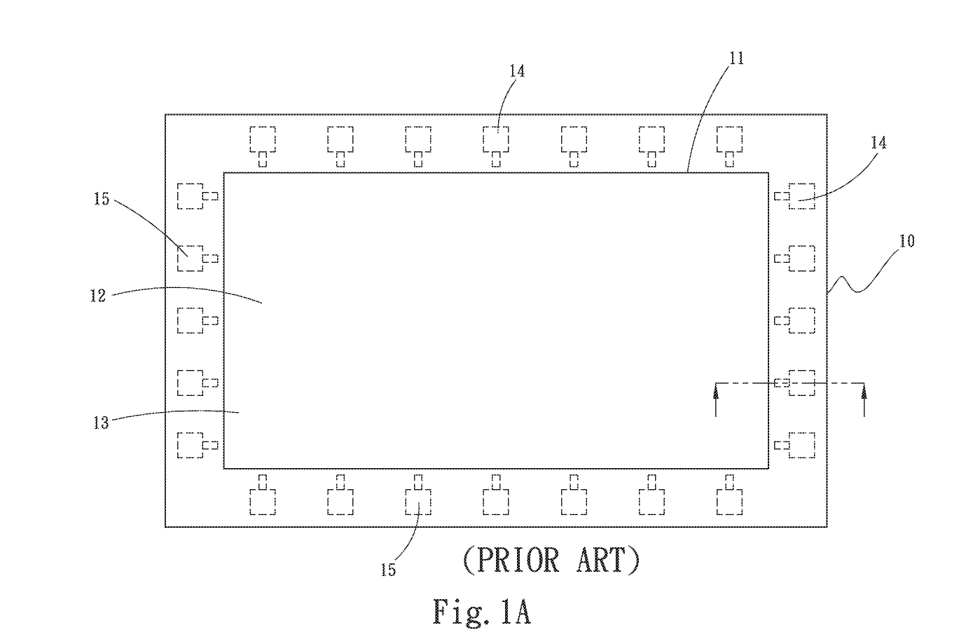

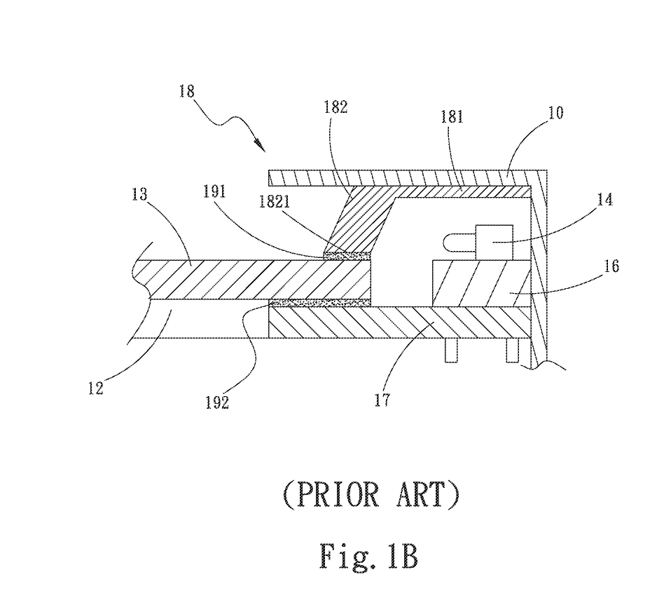

### DETAILED DESCRIPTION OF THE PREFERRED EMBODIMENTS

The embodiments of the present invention will be described hereinafter with reference to the drawings, wherein the same components are denoted with the same reference numerals.

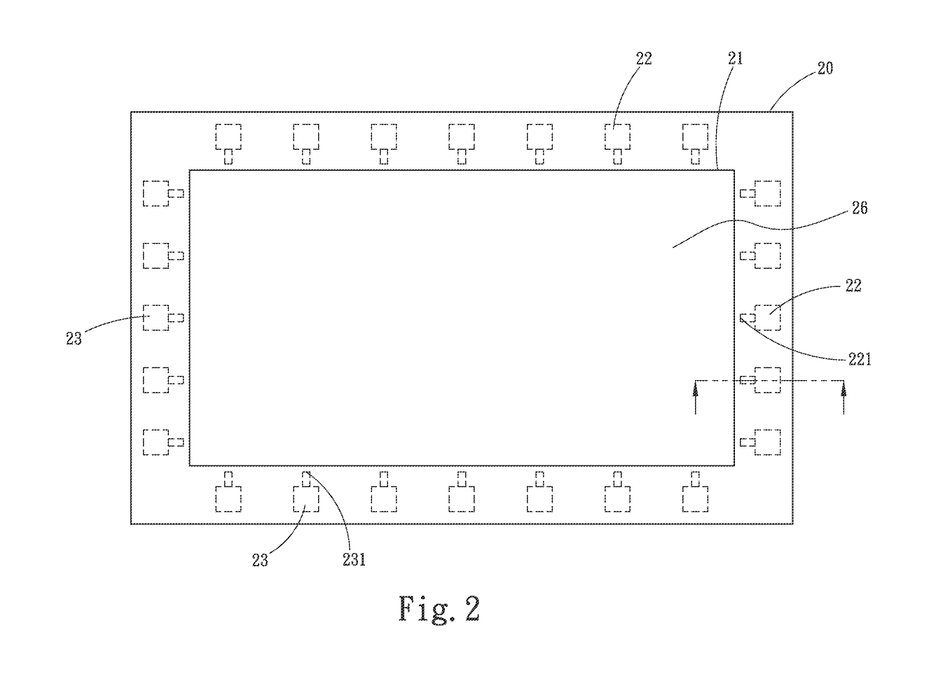

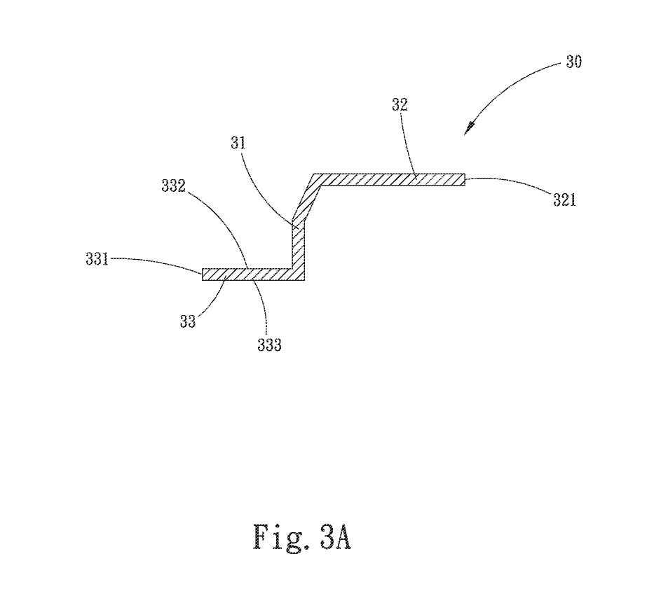

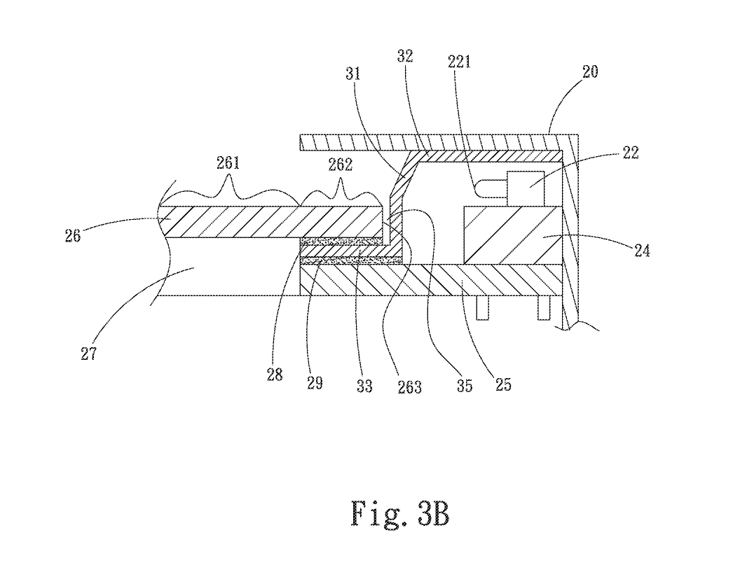

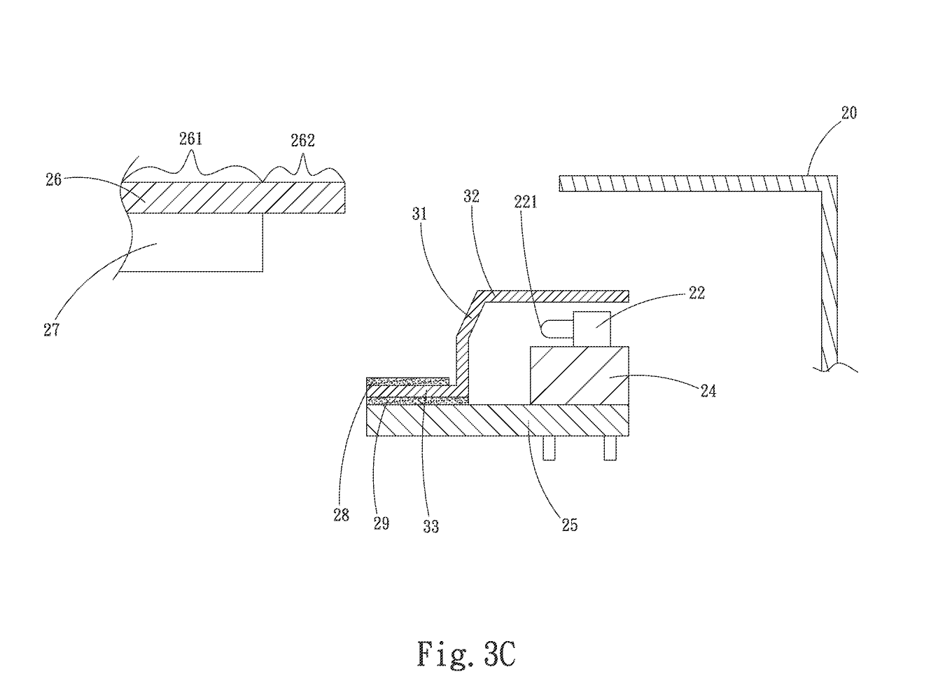

Please refer to FIGS. 2, 3A and 3B. FIG. 2 is a top view of the infrared touch module of the present invention. FIG. 3A is a sectional view of the first embodiment of the filter structure of the present invention. FIG. 3B is a sectional view showing that the first embodiment of the filter structure of the present invention is applied to an infrared touch module.

As shown in FIG. 2, a side frame 20 defines a window 21 therein. Two sets of corresponding infrared transmitters 22 and infrared receivers 23 are arranged on the opposite sides of the frame body 20. The infrared transmitters 22 and infrared receivers 23 are disposed on a first circuit board 24 (as shown in FIG. 3B). The first circuit board 24 is electrically connected with a second circuit board 25 (as shown in FIG. 3B). The first circuit board 24 is an LED circuit board, while the second circuit board 25 is a motherboard. Each infrared transmitter 22 has a transmission face 221 facing a receiving face 231 of each infrared receiver 23. A transparent panel 26 is positioned under the side frame 20 in alignment with the window 21. The infrared transmitters 22 and infrared receivers 23 are exposed to an upper surface of the transparent panel 26 to form an infrared sensing matrix above the transparent panel 26.

As shown in FIGS. 3A and 3B, the transparent panel 26 has a transparent section 261 exposed to the window 21. A display module 27 is positioned under the transparent section 26. The transparent panel 26 further has a concealed section 262 around the transparent section 26 and concealed by the side frame 29 corresponding to the second circuit board 25. The transparent panel 26 further has an outer periphery 263. In this embodiment, the transparent panel 26 is made of such as transparent silica glass, polymethylmethacrylate (PMMA), polycarbonate (PC) or polyethylene terephthalate (PET) for protecting the display module 27. The transparent panel 26 also provides a touch plane, (that is, the upper surface of the transparent panel 26), for a user to touch with a finger or a stylus. The light emitted from the display module 27 (such as an LCD display module) can pass through the transparent panel 26 to present an image to a user.

The filter structure 30 of the present invention has an upper protrusion section 32 and an extension section 33. The upper protrusion section 32 and the extension section 33 respectively angularly extend from an upper end and a lower end of the main body 31 in reverse directions. The upper protrusion section 32 extends to upper sides of the infrared transmitters 22 and infrared receivers 23. The extension section 33 extends to a position between the transparent panel 26 and the second circuit board 25. The upper protrusion section 32 and the extension section 33 are positioned on different levels. The upper protrusion section 32 has a protrusion end 321 and the extension section 33 has an extension end 331. The main body 31 is positioned in front of the transmission faces 221 of the infrared transmitters 22 and the receiving faces 231 of the infrared receivers 15 to shield the transmission faces 221 and the receiving faces 231. A gap 35 is defined between the outer periphery 263 of the transparent panel 26 and the main body 31.

The extension section 33 between the transparent panel 26 and the second circuit board 25 has an upper surface 332 and a lower surface 333. The upper surface 332 corresponds to the concealed section 262 of the transparent panel 26, while the lower surface 333 corresponds to the second circuit board 25.

A first adhesive layer 28 is disposed between the upper surface 332 of the extension section 33 and the concealed section 262 of the transparent panel 26. The first adhesive layer 28 has adhesion on both faces, whereby the extension section 33 is adhered under the concealed section 262 of the transparent panel 26. A second adhesive layer 29 is disposed between the lower surface 333 of the extension section 33 and the second circuit board 25. The second adhesive layer 29 has adhesion on both faces, whereby the extension section 33 is affixed to upper side of the second circuit board 25. The first and second adhesive layers 28, 29 are such as double-faced adhesive tape or the like.

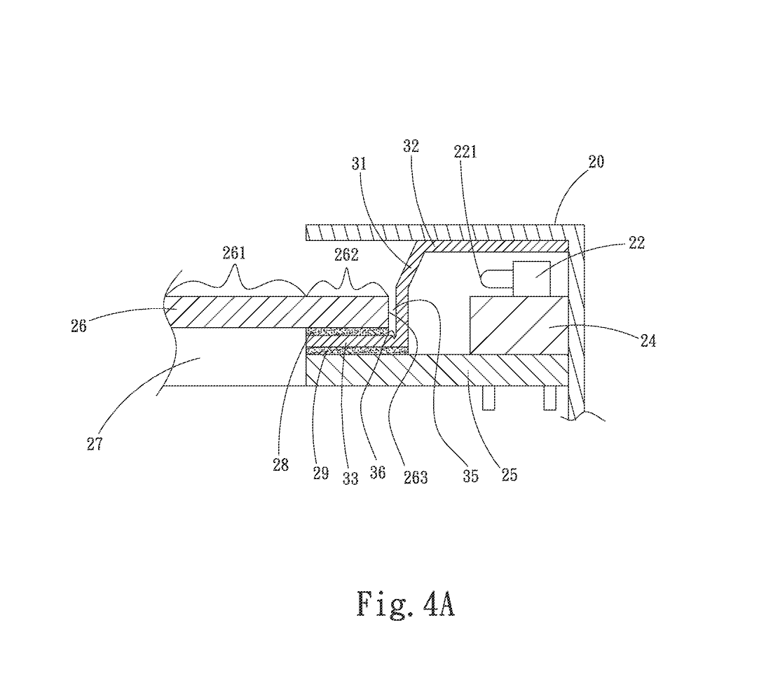

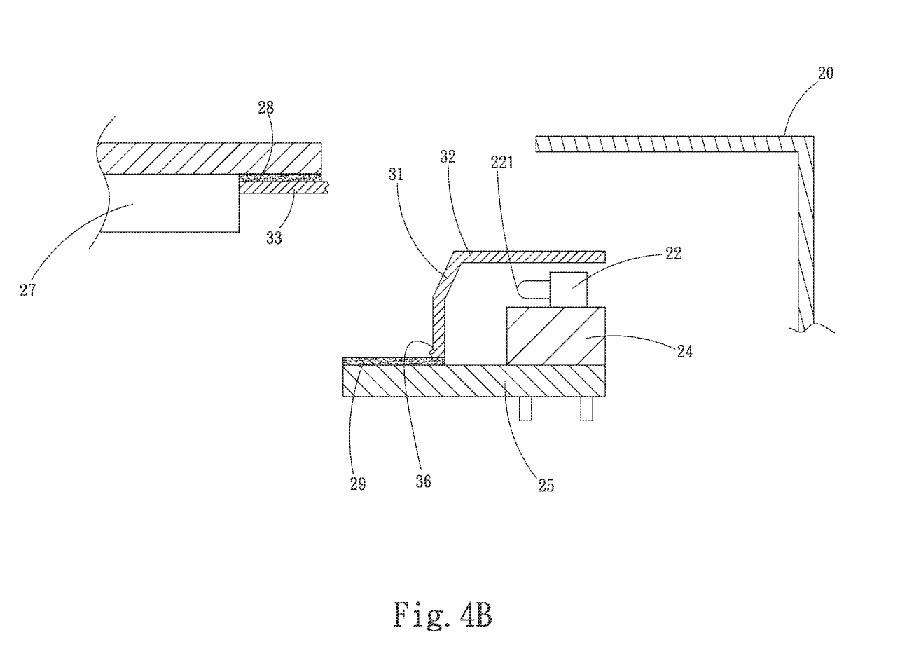

Please now refer to FIG. 3C, which is a sectional view showing the first manner in which the first embodiment of the present invention is detached. In the case that some components of the infrared touch module are damaged and need to be repaired, the side frame 20 is first detached and removed. Then, a slender and flat tool is inserted into the gap 35 between the outer periphery 263 of the transparent panel 26 and the main body 31 to detach the transparent panel 26 from the second circuit board 25. At this time, the transparent panel 26 may be directly separated from the upper side of the first adhesive layer 28. Alternatively, in another manner as shown in FIGS. 4A and 4B, the junction between the main body 31 and the extension section 33 is formed with a split 36. In the case that some components of the infrared touch module are damaged and need to be repaired, the side frame 20 is first detached and removed. Thereafter, a slender and flat tool is inserted into the gap 35 between the outer periphery 263 of the transparent panel 26 and the main body 31 to the bottom to forcedly break the filter structure 30. The force is concentrated on the split 36 so that the extension section 33 will break at the split 36 to separate from the main body 32. In both the above detaching manners, the second circuit 25 is prevented from being damaged. Therefore, the second circuit board 25 can keep complete. After the reparation is finished, the filter structure 30 is replaced with a new one to recover the infrared touch module.

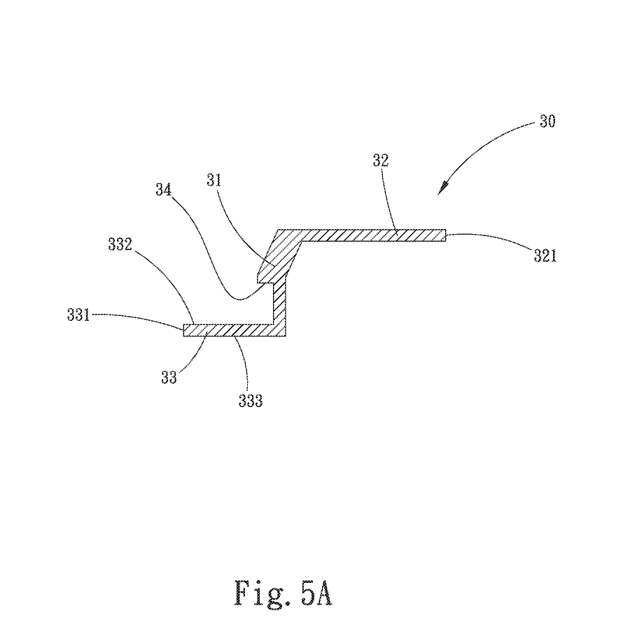

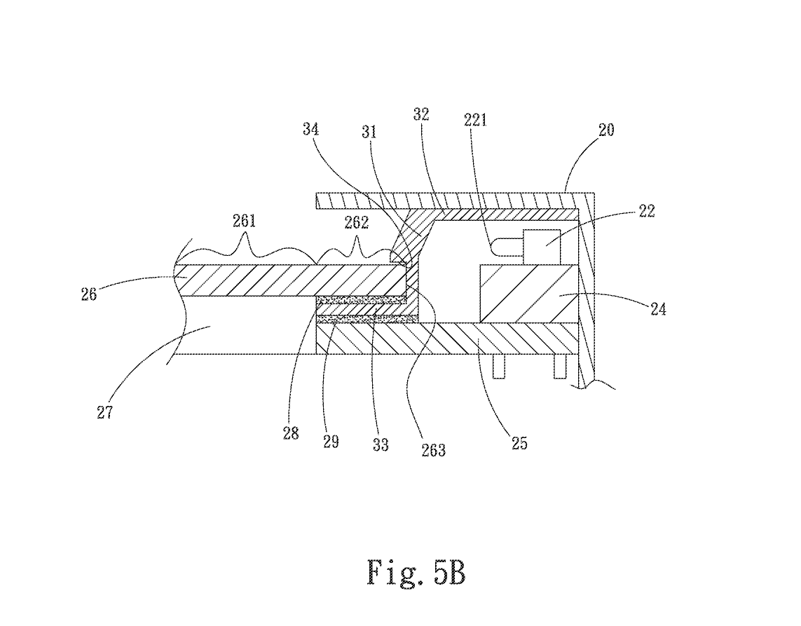

Please now refer to FIGS. 5A and 5B. In another embodiment, the main body 31 of the filter structure 30 is formed with a recess 34 on upper side of the extension section 33. In this case, the outer periphery 263 of the transparent panel 26 is received in the recess 34.

In conclusion, the filter structure of the present invention is positioned above and in front of the infrared transmitters and the infrared receivers to shield the same. The filter structure has an extension section extending between the transparent panel and the circuit board, whereby the circuit board is not directly adhered to the transparent panel. Accordingly, when separating the circuit board from the transparent panel, the circuit board is prevented from being damaged. In this case, the infrared touch module is repairable and reworkable.

The present invention has been described with the above embodiments thereof and it is understood that many changes and modifications in the above embodiments can be carried out without departing from the scope and the spirit of the invention that is intended to be limited only by the appended claims.

What is claimed is:

1. A filter structure of infrared touch module, which is applied to a side frame of the infrared touch module, the side frame having multiple infrared transmitters and multiple infrared receivers, the infrared transmitters and infrared receivers being disposed on a first circuit board, each infrared transmitter having a transmission face, each infrared receiver having a receiving face, the first circuit board being connected with a second circuit board, the side frame defining a window therein, a transparent panel being positioned under the side frame in alignment with the window, the transparent panel having a transparent section exposed to the window, a concealed section around the transparent section corresponding to the second circuit board and an outer periphery, the filter structure comprising:
a main body having an upper protrusion section and an extension section, the upper protrusion section and the extension section respectively extending from an upper end and a lower end of the main body in reverse directions, the upper protrusion section extending to upper sides of the infrared transmitters and infrared receivers, the main body being positioned in front of the transmission faces of the infrared transmitters and the receiving faces of the infrared receivers to shield the transmission faces and the receiving faces, the extension section extending to a position between the transparent panel and the second circuit board.

2. The filter structure of the infrared touch module as claimed in claim 1, wherein the extension section has an upper surface corresponding to the concealed section of the transparent panel and a lower surface corresponding to the second circuit board.

3. The filter structure of the infrared touch module as claimed in claim 2, wherein a first adhesive layer is disposed between the upper surface of the extension section and the concealed section of the transparent panel.

4. The filter structure of the infrared touch module as claimed in claim 3, wherein a second adhesive layer is disposed between the lower surface of the extension section and the second circuit board.

5. The filter structure of the infrared touch module as claimed in claim 1, wherein the upper protrusion section has a protrusion end and the extension section has an extension end.

6. The filter structure of the infrared touch module as claimed in claim 1, wherein the upper protrusion section and the extension section are positioned on different levels.

7. The filter structure of the infrared touch module as claimed in claim 1, wherein a gap is defined between the outer periphery of the transparent panel and the main body of the filter structure.

8. The filter structure of the infrared touch module as claimed in claim 1, wherein a of the infrared touch module as claimed in claim 1, wherein a junction between the main body and the extension section is formed with a split.

9. The filter structure of the infrared touch module as claimed in any of claims 1, wherein the main body is formed with a recess on upper side of the extension section, the outer periphery of the transparent panel being received in the recess.
